(19) United States
(12) Patent Application Publication
(10) Pub. No.: US 2014/0032180 A1
(43) Pub. Date: Jan. 30, 2014

(54) METHOD AND APPARATUS FOR COMPUTING DEFORMATION OF AN OBJECT

(71) Applicant: Samsung Electronics Co., Ltd., Suwon-si (KR)

(72) Inventors: Ji Yeon KIM, Hwaseong-si (KR); Hyong Euk LEE, Suwon-si (KR); Na Hyup KANG, Seoul (KR); Kyung Hwan KIM, Yongin-si (KR)

(21) Appl. No.: 13/902,346

(22) Filed: May 24, 2013

(30) Foreign Application Priority Data
Jul. 27, 2012 (KR) 10-2012-0082546

(51) Int. Cl. G06F 17/50

(52) U.S. Cl. CPC G06F 17/5018
USPC 703/1; 703/2

(57) ABSTRACT

Provided is a method and apparatus for computing an amount of deformation of an object. A parameter used to compute an amount of deformation in real time may be derived based on a shape model of the object, prior to computing an amount of deformation in real time. Accordingly, an amount of deformation of the object in real time may be predicted based on the parameter.

### CROSS-REFERENCE TO RELATED APPLICATION(S)

This application claims the benefit under 35 USC §119(a) of Korean Patent Application No. 10-2012-0082546, filed on Jul. 27, 2012, in the Korean Intellectual Property Office, the entire disclosure of which is incorporated herein by reference for all purposes.

### BACKGROUND

1. Field

The following description relates to a method and apparatus for computing an amount of deformation of an object in real time.

2. Description of Related Art

Estimating a deformation rate of an object has been widely employed for various industries ranging from a space launch vehicle and an artificial satellite to a nano scale semiconductor. For example, a finite element method (FEM) is widely used to compute an amount of deformation of an object. However, this method requires a relatively large amount of calculation. Therefore, the FEM may not compute a deformation while it occurs in real time.

As will be appreciated, when an organ moves a tumor that is located within the organ also moves. In particular, it may be difficult to verify an internal deformation of an organ, in real time, by performing physical modeling of the organ for the purpose of diagnosis and treatment of diseases. Alternatively, during an operation on an organ to remove a tumor growing within the organ, it may be difficult to verify, in real time, an amount of deformation of the organ which may make it difficult to locate an exact position of the tumor.

### SUMMARY

In an aspect, there is provided a method of computing an amount of deformation of an object, the method including deriving a primary parameter that predicts a distribution of deformation of the object, the primary parameter being based on a load condition applied to the object, and obtaining an amount of deformation of the object at a predetermined position of the object in an image, based on the primary parameter.

The deriving may comprise creating the shape model of the object from a three-dimensional (3D) image, extracting feature points of the object from the shape model, applying the load condition to the shape model, computing deformation information at the respective feature points based on the load condition, and deriving the primary parameter having the correlation with the load condition, based on the deformation information at the respective feature points.

The deriving may comprise setting the deformation information at the respective feature points as parameters, and deriving, as the primary parameter, a parameter having a positional change amount based on the load condition among the parameters.

The method may further comprise storing the load condition, the deformation information at the respective feature points, the positional change amount, and the primary parameter corresponding to the positional change amount.

The method may further comprise changing the load condition.

The computing may comprise computing the deformation information at the respective feature points based on the changed load condition.

The extracting may comprise extracting a first feature point from a surface of the shape model, and extracting a second feature point from an interior of the shape model.

The computing may comprise computing the deformation information at the first feature point and the second feature point, based on the load condition.

The deriving may comprise deriving the primary parameter having the correlation with the load condition, based on load conditions at the respective first feature point and second feature point.

The obtaining may comprise searching for a real-time load condition from the real-time image, mapping the real-time load condition to load conditions at the respective feature points, calling primary parameters corresponding to the load conditions at the respective feature points, and obtaining an amount of deformation of the object at the predetermined position of the object based on the primary parameters.

In an aspect, a non-transitory computer-readable medium may comprise a program for instructing a computer to perform the method.

In an aspect, there is provided an apparatus for computing an amount of deformation of an object, the apparatus including a preprocessing module configured to derive a primary parameter that predicts a distribution of deformation of the object, the primary parameter being based on a load condition applied to the object, and a processor configured to obtain an amount of deformation of the object at a predetermined position of the object in an image, based on the primary parameter.

The preprocessing module may comprise a creator configured to create the shape model of the object from a three-dimensional (3D) image, an extractor configured to extract feature points of the object from the shape model, a computing unit configured to compute deformation information at the respective feature points based on the load condition, and a deriving unit configured to derive the primary parameter based on the deformation information at the respective feature points.

The deriving unit may be configured to set the deformation information at the respective feature points as parameters, and to derive, as the primary parameter, a parameter having a positional change amount based on the load condition among the parameters.

The apparatus may further comprise a database configured to store the load condition, the deformation information at the respective feature points, the positional change amount, and the primary parameter corresponding to the positional change amount.

The apparatus may further comprise a changing unit configured to apply and change the load condition.

The computing unit may be configured to compute the deformation information at the respective feature points based on the changed load condition.

The extractor may be configured to extract a first feature point from a surface of the shape model, and to extract a second feature point from an interior of the shape model.

The computing unit may be configured to compute the deformation information at the first feature point and the second feature point, based on the load condition.

The deriving unit may be configured to derive the primary parameter based on load conditions at the respective first feature point and second feature point.

The processor may comprise a search unit configured to search for a real-time load condition from the image, a mapping unit configured to map the real-time load condition to load conditions at the respective feature points, a calling unit configured to call primary parameters corresponding to each of the load conditions at the respective feature points, and an obtaining unit configured to obtain an amount of deformation of the object at the predetermined position of the object based on the primary parameters.

In an aspect, there is provided an apparatus to predict movement of an object, the apparatus including a preprocessor configured to generate a plurality of movement parameters of the object, each movement parameter comprising a predicted distribution of movement of the object based on a predicted force applied to the object, and a processor configured to determine an external force applied to the object shown in an image, and apply a movement parameter to the object in the image based on the determined external force to generate a predicted movement image of the object.

The preprocessor may generate a shape model of the object, generate the plurality of movement parameters by extracting features points from the shape model, and predict the distribution of movement of each of the features points based on the predicted force applied to the object.

The processor may apply the movement parameter to features points of the object in the image to predict the distribution of movement of the feature points in the image.

Other features and aspects will be apparent from the following detailed description, the drawings, and the claims.

### BRIEF DESCRIPTION OF THE DRAWINGS

FIG. 1 is a flowchart illustrating an example of a method of computing an amount of deformation of an object.

FIG. 2 is a flowchart illustrating an example of preprocessing process for deriving a primary parameter.

FIG. 3 is a drawing illustrating an example of a shape model of a deformable object.

FIGS. 4 and 5 are diagrams illustrating examples of extracting feature points of a deformable object.

FIG. 6 is diagram illustrating an example of a change in a shape model when a load condition is applied.

FIG. 7 is a diagram illustrating an example of a result of deforming an object based on the load condition of FIG. 6.

FIG. 8 is a group of diagrams illustrating examples of a variety of load conditions applied to a deformable object.

FIG. 9 is a diagram illustrating an example of a method of deriving a primary parameter.

FIG. 10 is a flowchart illustrating an example of a real-time method for obtaining an amount of deformation of an object at a predetermined position of the object in a real-time image.

FIG. 11 is a diagram illustrating an example of a process of searching for a real-time load condition from a real-time image using the method of FIG. 10.

FIG. 12 is a diagram illustrating an example of a process of mapping the real-time load condition of FIG. 11 to load conditions at the respective feature points.

FIG. 13 is a diagram illustrating an example of an apparatus for computing an amount of deformation of an object.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

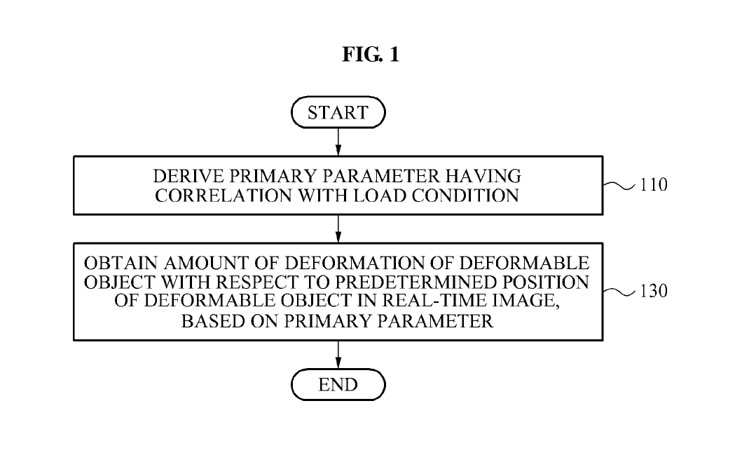

FIG. 1 illustrates an example of a method of computing an amount of deformation of an object. The method may be performed by an apparatus for computing an amount of deformation of an object in real time.

Referring to FIG. 1, in 110, the apparatus derives a primary parameter having a correlation with a load condition that acts on a shape model of the deformable object. The object may be an elastic body or a non-rigid object that may be deformed, for example, a human organ, of which a shape is deformable due to external stimulus.

According to various aspects, a primary parameter capable of predicting a distribution of deformation may be derived. The primary parameter may be used to obtain an actual amount of deformation of the object occurring at a desired position of an interior or on a surface of the object. For example, the primary parameter may be derived based on deformation information. In this example, the deformation information may have a correlation with an amount of deformation based on a deformation condition.

For example, a primary parameter in which a physical characteristic is maximally reflected may be extracted based on an analysis result that is obtained using a finite element method (FEM). The FEM may be based on a shape model of a deformable object. In this example, the primary parameter may have a correlation with a load condition or an amount of deformation based on the load condition.

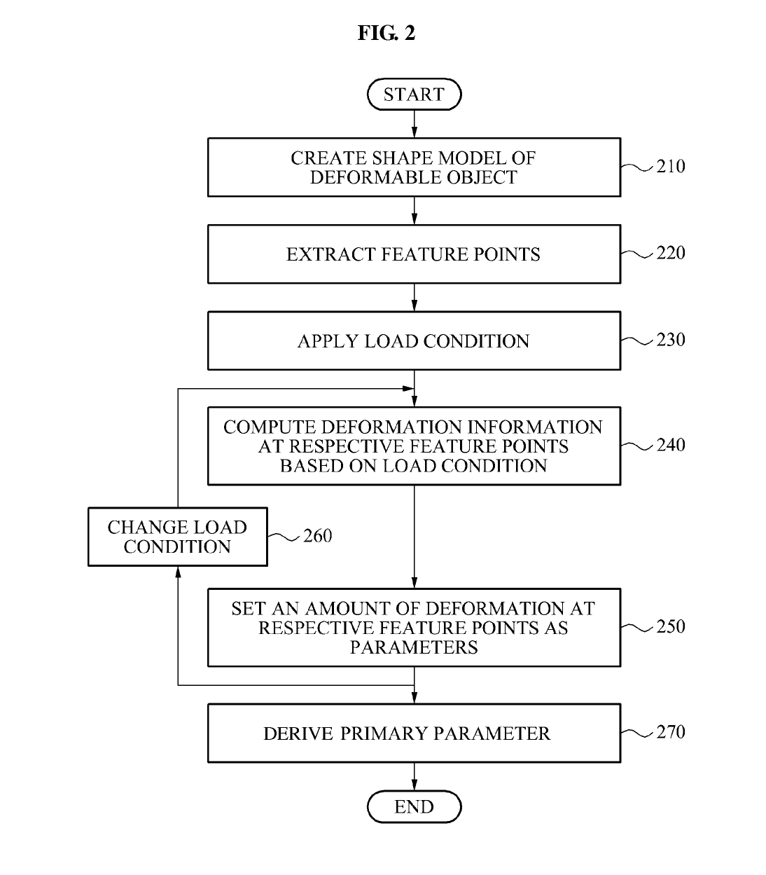

A process of deriving a primary parameter is referred to as a preprocessing process. The preprocessing process may be performed prior to performing real-time processing with respect to a real-time image captured during an operation. Therefore, a computation time or constraint of a memory may not be considered. An example of the preprocessing process is described with reference to FIG. 2.

In 130, the apparatus obtains an amount of deformation of the object at a predetermined position of the object in an image, based on the primary parameter. For example, a deformation rate of the deformable object may be verified in real time through a computation using the primary parameter that is derived during the preprocessing process. In this case, the apparatus may derive a primary parameter with respect to an external force that is applied to the object that has a shape that varies in real time, and may obtain an amount of deformation of the object in real time through simple computation between primary parameters.

The apparatus may obtain an amount of deformation of the object at a predetermined position of the object in real time. For example, in a case in which a portion of an organ is to be excised to remove a tumor growing therein, the apparatus may display an amount of deformation of the organ, in real time. Therefore, if a position of the tumor moves as a result of the deformation, this movement can be displayed in real time.

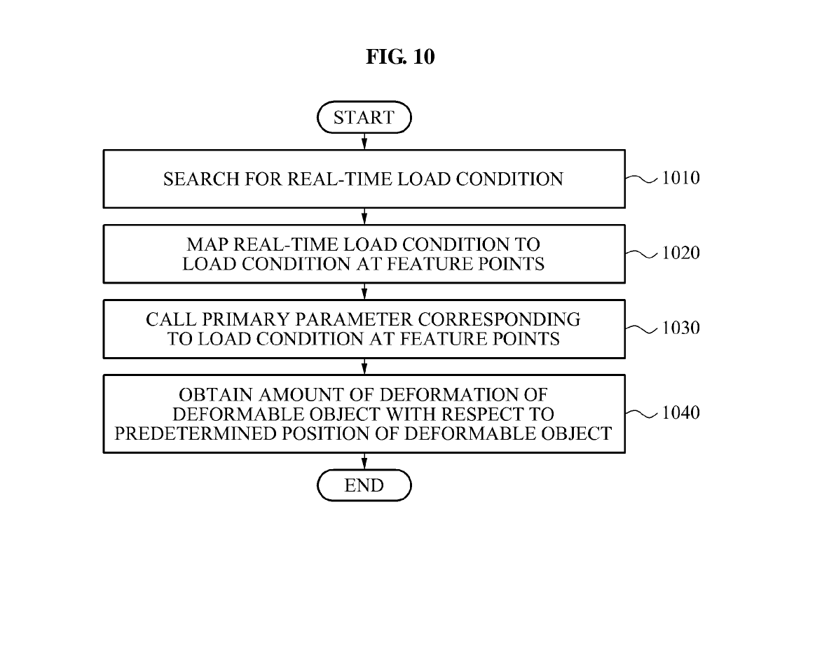

A process of obtaining a deformation of an object from a real-time image may be referred to as a real-time process. An example of the real-time process is described with reference to FIG. 10.

FIG. 2 illustrates an example of a preprocessing process for deriving a primary parameter.

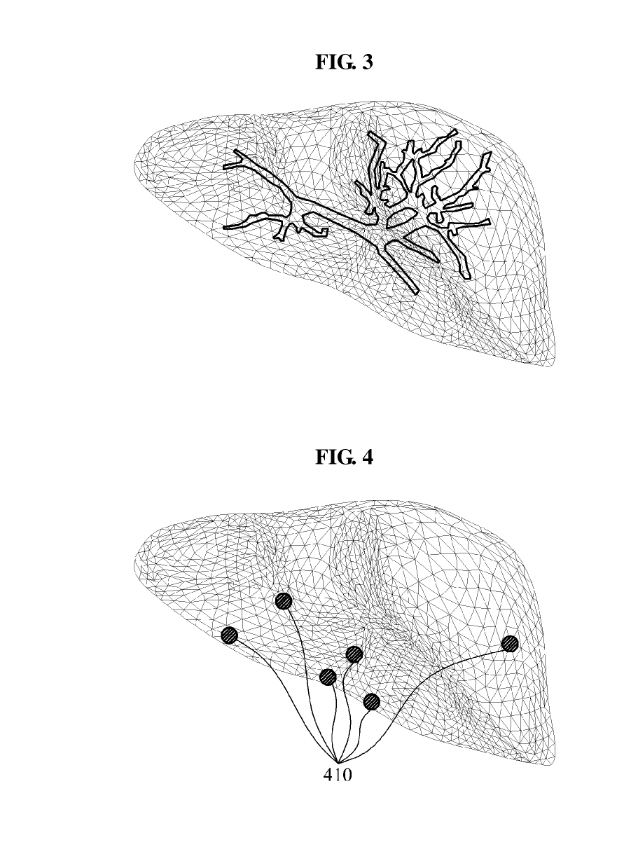

Referring to FIG. 2, in 210, an apparatus creates a shape model of a deformable object from a three-dimensional (3D) image. An example of the shape model of the deformable object created in 210 is described with reference to FIG. 3. Organs, for example, a liver and a heart in the 3D image may be expressed as models having different properties. The 3D image may be a 3D medical image captured from, for example, a computed tomography (CT), a magnetic resonance imaging (MRI), and the like.

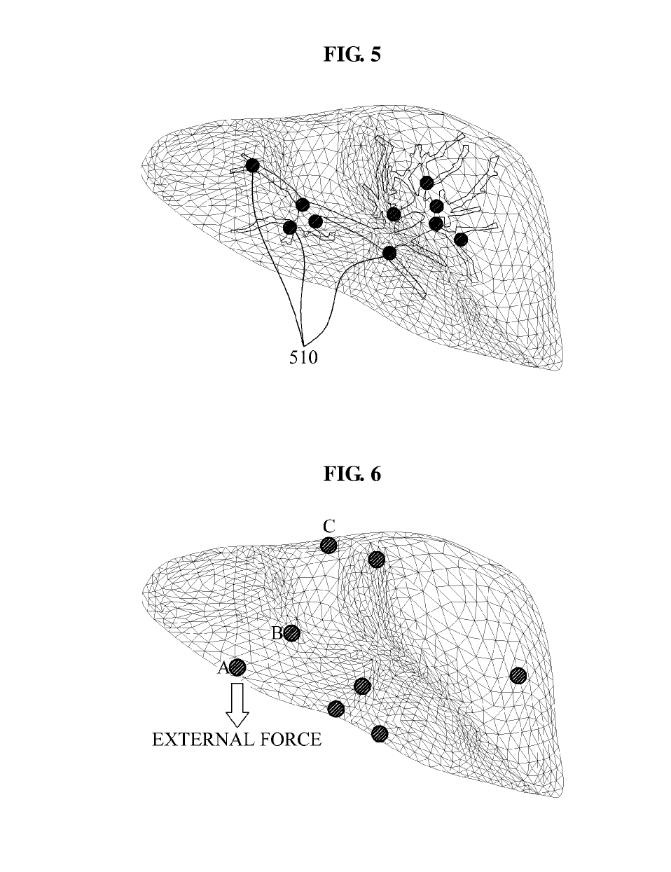

In 220, the apparatus extracts feature points from the shape model. The feature points may be extracted through the examples of FIG. 4 and FIG. 5.

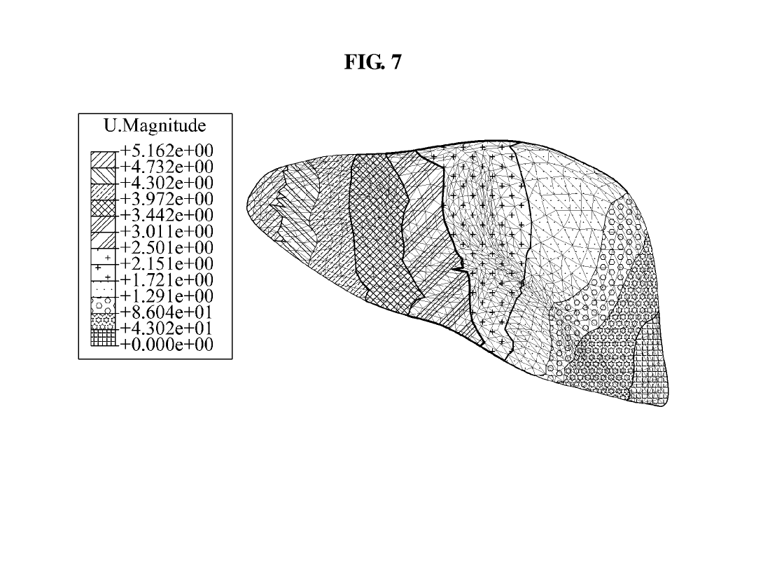

The apparatus applies a load condition to the shape model in 230, and computes deformation information at the respective feature points based on the load condition in 240. For example, the deformation information may include a change in a shape, a change in volume, a change in mass distribution, an internal physical characteristic distribution, an amount of deformation of the object, and the like. An example of a method of applying a load condition is described with reference to FIG. 6. An example of an amount of deformation at the respective feature points based on a load condition is described with reference to FIG. 7. The apparatus may derive a primary parameter having a correlation with the load condition based on the deformation information at the respective feature points.

In 250, the apparatus sets an amount of deformation at the respective feature points as parameters indicating a change in a position with respect to a region of interest (ROI) of the object.

In 260, the apparatus sets an amount of deformation at the respective feature points as the parameters and changes the load condition. Based on the changed load condition, a process of 240 and 250 may be repeated. For example, the term “parameter” used herein may be a level of change or an amount of change in a position of a feature point occurring due to a predetermined load condition.

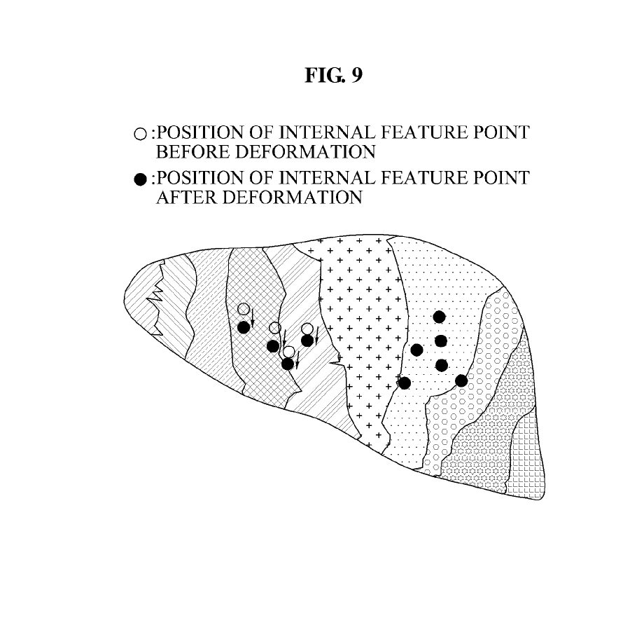

The apparatus may compute all of the deformation information at the respective feature points based on all of the load conditions, and may repeat a process of 240 and 250 until the computed deformation information is set as parameters. By repeating the process of 240 and 250, the apparatus may construct a database of parameters with respect to a variety of load conditions. An example of a variety of load conditions is described with reference to FIG. 9.

In 270, the apparatus derives, as the primary parameter, a parameter having a positional change amount based on the load condition. An example of a method of deriving a primary parameter is described with reference to FIG. 9.

FIG. 3 illustrates an example of a shape model of a deformable object created using the method of FIG. 2. The shape model may be displayed on a display unit included in a device, such as a computer, a television, a medical device, and the like.

As an example, a shape model of a deformable object may be obtained using a 3D scanner. In the case of obtaining a shape model of an organ to compute a deformation level of the organ for the medical purpose, for example, a CT, an MRI, and the like may be employed. Referring to FIG. 3, the shape model of the deformable object may be configured as a tetrahedral mesh model to analyze a shape of the object. As merely an example, an aspect ratio of a mesh may be determined to be within “10”. For an accurate analysis, the mesh may need to maintain a volume with regular deviation.

For example, when the given 3D image is a medical image of an organ of a patient as illustrated in FIG. 3, the shape model of the deformable object may be configured as the tetrahedral mesh model fitted for a shape of the organ of the patient. The tetrahedral mesh model may include substructures of the organ, for example, blood vessels, nerves, and the like. The organ, blood vessel, and a tumor may be expressed as models having different properties.

FIG. 4 and FIG. 5 illustrate examples of a method of extracting feature points of a deformable object. In these examples, FIG. 4 illustrates first feature points 410 extracted from the surface of a shape model, and FIG. 5 illustrates second feature points 510 extracted from an interior of the shape model.

Feature points may be positioned on the interior and/or on the exterior of a shape model of a deformable object, and a global deformation of the object may be verified through the feature points. For example, analysis and computation may be performed by indicating a predetermined load that is applied to the deformable object.

The first feature points 410 are positioned on the surface of the shape model to which the load or external force is applied. The first feature points 410 may correspond to points that accurately express the shape of the deformable object, and may be extracted from, for example, a point of infection or a position at which the shape significantly changes.

In the case of a shape model of an internal organ created from a 3D medical image, the second feature points 510 may be extracted from, for example, a tree-shaped skeletal structure of internal blood vessels, a branching point and extreme phase of internal blood vessels, a point capable of expressing a position of a tumor, and the like.

FIG. 6 illustrates an example of a change in a shape model when a load condition is applied.

According to various aspects, a variety of load conditions may be applied to the deformable object, and an amount of deformation at the respective feature points may be computed based on the applied load conditions.

Referring to FIG. 6, in a case in which a downward external force is applied to a feature point A positioned on the surface of the deformable object, the downward external force may be applied as a load condition. For example, the downward force may be an external force pulling feature point A downward in the image.

In the case of pulling the feature point A downward, feature points B and C that are neighboring to the feature point A, or connected thereto as muscle or nerve as well as the feature point A may also be affected by the downward external force. In addition, the external force may act with respect to internal feature points of the deformable object.

Accordingly, by applying a load condition, and by computing and storing to deformation information such as an amount of deformation at respective internal and external feature points based on the applied load condition, the deformation information may be used to compute an amount of deformation in a real-time image. An example of deformation information including an amount of deformation at the feature points based on a load condition is illustrated in FIG. 7.

FIG. 7 illustrates an example of a result of deforming an object based on the load condition of FIG. 6.

Referring to FIG. 7, a result of performing analysis using an FEM after applying the load condition of FIG. 6 to the object is illustrated. The FEM is an example of a structural analysis and a method of obtaining an approximate value by computing a numerical value about various factors such as rigidity, stress distribution, and an amount of change of a structure that occurs when an external force is applied to the structure. In addition to the FEM, other structural analysis methods, for example, a differential element method (DEM) and a boundary element method (BEM) may be employed to compute an amount of deformation of the deformable object.

As illustrated in FIG. 7, through the structural analysis, a deformation distribution in the object may be provided and an amount of deformation at the respective feature points based on the load condition may be verified from the deformation distribution.

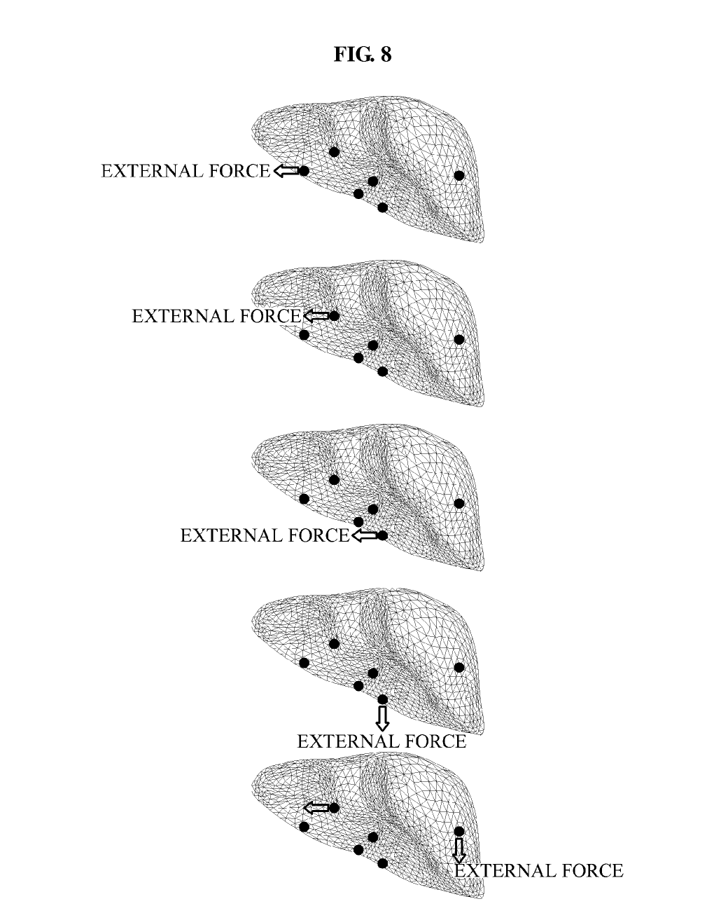

FIG. 8 illustrates an example of a variety of load conditions applied to a deformable object.

In FIG. 8, a variety of load conditions applied to the deformable object may be used to verify, in advance, external force candidate sets when an external force or deformation is practically applied to the deformable object in a real-time operative image.

For example, external force candidate sets applicable to the deformable object may be verified in advance by changing a load condition as described above with reference to 260 of FIG. 2. Each of the external force candidate sets may correspond to an individual unit load set that is capable of expressing all of the load conditions.

According to various aspects, by computing deformation information including an amount of deformation at the respective points based on a changed load condition, deformation information of external force candidate sets applicable to the object may also be computed in advance. Deformation information of the external force candidate sets and an external force corresponding thereto, for example, a load condition may be stored in a database. Deformation information repeatedly computed may be expressed as a value at the same feature point.

FIG. 9 illustrates an example of a method of deriving a primary parameter in a method of computing an amount of deformation of an object in real time.

Referring to FIG. 9, an apparatus may set, as parameters, deformation information including an amount of deformation at the respective feature points. The apparatus may derive, as a primary parameter, a parameter that has a positional change amount based on a load condition among the set parameters. For example, deformation information at the respective feature points in a shape model of a human organ, for example, a liver, may be set as a parameter.

In FIG. 9, white dots refer to positions of internal feature points before deformation occurs. Black dots refer to positions of internal points after the deformation occurs based on the load condition. The white dots may include deformation information at the respective internal feature points with respect to ROIs such as internal blood vessel and a tumor which may be set as parameters.

Among the set parameters, a feature point of which position varies based on a load condition, for example, a parameter having a positional change amount based on the load condition may be derived as a primary parameter. An amount of deformation at the respective feature points may be expressed by Equation 1.

Amount of Deformation (u, v, w)=F(x, y, z, pⁿᵢ, . . . ) [Equation 1]

In Equation 1, u, v, and w denote an amount of deformation in directions x, y, and z, respectively, and x, y, and z denote positions of feature points of which an amount of deformation is to be obtained, respectively, and Pⁿᵢ denotes a representing amount of change of internal feature point(s) i based on an n^{th} load condition.

FIG. 10 illustrates an example of a real-time method for obtaining an amount of deformation of an object at a predetermined position of the object in a real-time image.

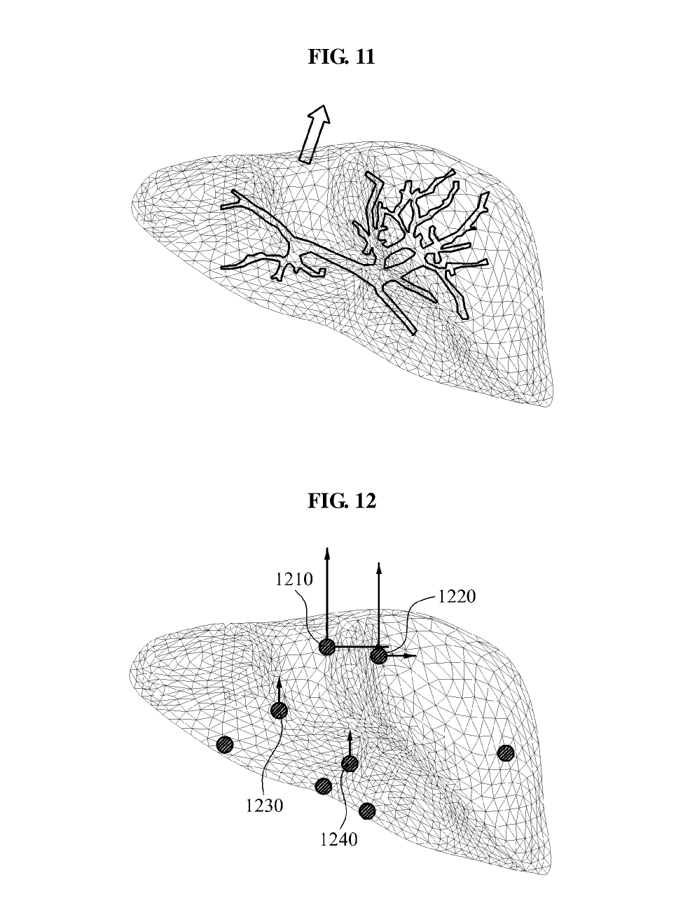

Referring to FIG. 10, in 1010, an apparatus searches a real-time image for a real-time load condition applied using a surgical instrument and the like. The real-time image may be an image that is captured using an endoscope during an operation. An example of a process of searching for the real-time load condition is described with reference to FIG. 11.

In 1020, the apparatus maps the real-time load condition to load conditions at the respective feature points. An example of a process of mapping the real-time load condition to the load conditions at the respective feature points is described with reference to FIG. 12.

In 1030, the apparatus calls primary parameters corresponding to the load conditions at the respective feature points.

In 1040, the apparatus obtains an amount of deformation of the object at the predetermined position of the object based on the primary parameters.

FIG. 11 illustrates an example of a process of searching for a real-time load condition from a real-time image using the method of FIG. 10.

Referring to FIG. 11, an external force acts in an indicator direction in the real-time image. For example, the process of searching the real-time image for the load condition may be to search for a displacement condition practically applied by a surgical instrument based on the real-time image. In the real-time image, an external force applied to the deformable object, for example, the liver, may be expressed as a set of independent load conditions obtained during the preprocessing process or a combination thereof.

FIG. 12 illustrates an example of a process of mapping the real-time load condition of FIG. 11 to load conditions at the respective feature points.

Referring to FIG. 12, when the external force acting in the indicator direction of FIG. 11 is external force 1, the external force 1 may cause deformation at feature points, for example, a feature point (1) 1210, a feature point (2) 1220, a feature point (3) 1230, and a feature point (4) 1240.

The external force 1 acting at the respective feature points may be expressed based on load conditions at the respective feature points that are obtained during the preprocessing process. For example, the external force 1 acting in the indicator direction in a predetermined area of the real-time image may correspond to a combination of load conditions 1, 3, and 4 that are obtained during the preprocessing process. In this case, the external force 1 in the real-time image may be mapped to the load conditions 1, 3, and 4. An amount of deformation based on each load condition may be computed in advance based on a primary parameter with respect to corresponding feature points through the preprocessing process.

For example, when the apparatus calls a primary parameter with respect to corresponding feature points, an amount of deformation p¹₁, p¹₂, p¹₃, p¹₄ at the feature point (1) 1210, the feature point (2) 1220, the feature point (3) 1230, and the feature point (4) 1240 based on the load condition 1, an amount of deformation p³₁, p³₂, p³₃, p³₄ at the feature point (1) 1210, the feature point (2) 1220, the feature point (3) 1230, and the feature point (4) 1240 based on the load condition 3, and an amount of deformation p⁴₁, p⁴₂, p⁴₃, p⁴₄ at the feature point (1) 1210, the feature point (2) 1220, the feature point (3) 1230, and the feature point (4) 1240 based on the load condition 4 may be called.

The apparatus may obtain an amount of deformation at a predetermined position through simple computation between primary parameters with respect to corresponding feature points. For example, in the case of a medical image, an amount of deformation at all of the points with respect to internal blood vessel and a tumor may be obtained by performing linear approximation with respect to deformation at internal feature points.

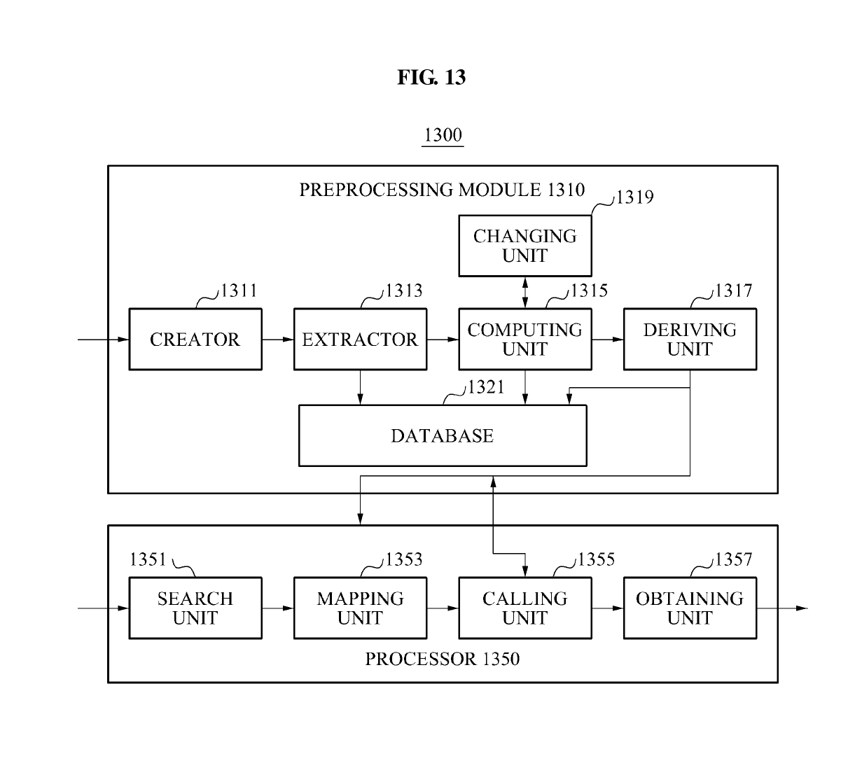

FIG. 13 illustrates an example of an apparatus 1300 (hereinafter, a real-time computing apparatus 1300) for computing an amount of deformation of an object in real time.

Referring to FIG. 13, the apparatus 1300 includes a preprocessing module 1310 and a processor 1350.

The preprocessing module 1310 may derive a primary parameter having a correlation with a load condition that acts on a shape model of the deformable object. The preprocessing module 1310 includes a creator 1311, an extractor 1313, a computing unit 1315, a deriving unit 1317, a changing unit 1319, and a database 1321.

The creator 1311 may create the shape model of the deformable object from a 3D image. The extractor 1313 may extract feature points from the shape model. For example, the extractor 1313 may extract a first feature points from the surface of the shape model, and may extract a second feature point from an interior of the shape model.

The computing unit 1315 may compute deformation information at the respective feature points based on the load condition. For example, the computing unit 1315 may compute deformation information based on load conditions at the respective first feature point and second feature point.

The deriving unit 1317 may derive the primary parameter having the correlation with the load condition, based on the deformation information at the respective feature points. For example, the deriving unit 1317 may set the deformation information at the respective feature points as parameters, and may derive, as the primary parameter, a parameter that has a positional change amount based on the load condition among the parameters. The deriving unit 1317 may derive the primary parameter having the correlation with the load condition based on load conditions at the respective first feature point and second feature point.

The changing unit 1319 may change the load condition. The computing unit 1315 may compute the deformation information at the respective feature points based on the changed load condition. The database 1321 may store the load condition, the deformation information at the respective feature points based on the load condition, the positional change amount, and the primary parameter corresponding to the positional change amount.

The processor 1350 may obtain an amount of deformation of the object at a predetermined position of the object in a real-time image, based on the primary parameter. The processor 1350 includes a search unit 1351, a mapping unit 1353, a calling unit 1355, and an obtaining unit 1357.

The search unit 1351 may search for a real-time load condition from the real-time image. The mapping unit 1353 may map the real-time load condition to the load conditions at the respective feature points. The calling unit 1355 may call primary parameters corresponding to the load conditions at the respective feature points. The obtaining unit 1357 may obtain an amount of deformation at the predetermined position of the object based on the primary parameters.

The apparatus 1300 may further include a display unit (not shown) that may be used to show images of an object, in real time.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of computing an amount of deformation of an object, the method comprising:
deriving a primary parameter that predicts a distribution of deformation of the object, the primary parameter being based on a load condition applied to the object; and
obtaining an amount of deformation of the object at a predetermined position of the object in an image, based on the primary parameter.

2. The method of claim 1, wherein the deriving comprises:
creating the shape model of the object from a three-dimensional (3D) image;
extracting feature points of the object from the shape model;
applying the load condition to the shape model;
computing deformation information at the respective feature points based on the load condition; and
deriving the primary parameter having the correlation with the load condition, based on the deformation information at the respective feature points.

3. The method of claim 2, wherein the deriving comprises:
setting the deformation information at the respective feature points as parameters; and
deriving, as the primary parameter, a parameter having a positional change amount based on the load condition among the parameters.

4. The method of claim 3, further comprising:
storing the load condition, the deformation information at the respective feature points, the positional change amount, and the primary parameter corresponding to the positional change amount.

5. The method of claim 2, further comprising:
changing the load condition.

6. The method of claim 5, wherein the computing comprises computing the deformation information at the respective feature points based on the changed load condition.

7. The method of claim 2, wherein the extracting comprises:
extracting a first feature point from a surface of the shape model, and extracting a second feature point from an interior of the shape model.

8. The method of claim 7, wherein the computing comprises computing the deformation information at the first feature point and the second feature point, based on the load condition.

9. The method of claim 7, wherein the deriving comprises deriving the primary parameter having the correlation with the load condition, based on load conditions at the respective first feature point and second feature point.

10. The method of claim 2, wherein the obtaining comprises:
searching for a real-time load condition from the real-time image;
mapping the real-time load condition to load conditions at the respective feature points;
calling primary parameters corresponding to the load conditions at the respective feature points; and
obtaining an amount of deformation of the object at the predetermined position of the object based on the primary parameters.

11. A non-transitory computer-readable medium comprising a program for instructing a computer to perform the method of claim 1.

12. An apparatus for computing an amount of deformation of an object, the apparatus comprising:
a preprocessing module configured to derive a primary parameter that predicts a distribution of deformation of the object, the primary parameter being based on a load condition applied to the object; and
a processor configured to obtain an amount of deformation of the object at a predetermined position of the object in an image, based on the primary parameter.

13. The apparatus of claim 12, wherein the preprocessing module comprises:
a creator configured to create the shape model of the object from a three-dimensional (3D) image;
an extractor configured to extract feature points of the object from the shape model;
a computing unit configured to compute deformation information at the respective feature points based on the load condition; and
a deriving unit configured to derive the primary parameter based on the deformation information at the respective feature points.

14. The apparatus of claim 13, wherein the deriving unit is configured to set the deformation information at the respective feature points as parameters, and to derive, as the primary parameter, a parameter having a positional change amount based on the load condition among the parameters.

15. The apparatus of claim 14, further comprising:
a database configured to store the load condition, the deformation information at the respective feature points, the positional change amount, and the primary parameter corresponding to the positional change amount.

16. The apparatus of claim 13, further comprising:
a changing unit configured to apply and change the load condition.

17. The apparatus of claim 16, wherein the computing unit is configured to compute the deformation information at the respective feature points based on the changed load condition.

18. The apparatus of claim 13, wherein the extractor is configured to extract a first feature point from a surface of the shape model, and to extract a second feature point from an interior of the shape model.

19. The apparatus of claim 18, wherein the computing unit is configured to compute the deformation information at the first feature point and the second feature point, based on the load condition.

20. The apparatus of claim 18, wherein the deriving unit is configured to derive the primary parameter based on load conditions at the respective first feature point and second feature point.

21. The apparatus of claim 13, wherein the processor comprises:
a search unit configured to search for a real-time load condition from the image;
a mapping unit configured to map the real-time load condition to load conditions at the respective feature points;
a calling unit configured to call primary parameters corresponding to each of the load conditions at the respective feature points; and
an obtaining unit configured to obtain an amount of deformation of the object at the predetermined position of the object based on the primary parameters.

22. An apparatus to predict movement of an object, the apparatus comprising:
a preprocessor configured to generate a plurality of movement parameters of the object, each movement parameter comprising a predicted distribution of movement of the object based on a predicted force applied to the object; and
a processor configured to determine an external force applied to the object shown in an image, and apply a movement parameter to the object in the image based on the determined external force to generate a predicted movement image of the object.

23. The method of claim 22, wherein the preprocessor generates a shape model of the object, generates the plurality of movement parameters by extracting features points from the shape model, and predicts the distribution of movement of each of the features points based on the predicted force applied to the object.

24. The method of claim 23, wherein the processor applies the movement parameter to features points of the object in the image to predict the distribution of movement of the feature points in the image.
